(19) United States
(12) Patent Application Publication
(10) Pub. No.: US 2014/0168117 A1
(43) Pub. Date: Jun. 19, 2014

(54) MOBILE TERMINAL AND METHOD FOR OPERATING THE SAME

(71) Applicants: Sungeun KIM, Seoul (KR); Hyunju KIM, Seoul (KR); Eunhee YI, Seoul (KR); Kichu HONG, Seoul (KR); Jinyung PARK, Seoul (KR)

(72) Inventors: Sungeun KIM, Seoul (KR); Hyunju KIM, Seoul (KR); Eunhee YI, Seoul (KR); Kichu HONG, Seoul (KR); Jinyung PARK, Seoul (KR)

(21) Appl. No.: 14/051,130

(22) Filed: Oct. 10, 2013

(30) Foreign Application Priority Data
Oct. 16, 2012 (KR) 10-2012-0114954

(51) Int. Cl. G06F 3/0488

(52) U.S. Cl. CPC G06F 3/0488
USPC 345/173

(57) ABSTRACT

A method for operating a mobile terminal includes detecting whether pressure is applied via a plurality of sensors, detecting the level of the pressure, entering a call recording mode for recording content of a telephone call if the detected level of the pressure is greater than a reference value and the telephone call is established, and entering a memo mode if the detected level of the pressure is greater than the reference value and the telephone call is not established. Accordingly, a user can easily and conveniently utilize a function and rapidly perform a predetermined operation or function. Therefore, it is possible to increase user convenience.

### CROSS-REFERENCE TO RELATED APPLICATION

This application claims the priority benefit of Korean Patent Application No. 10-2012-0114954, filed on Oct. 16, 2012 in the Korean Intellectual Property Office, the disclosure of which is incorporated herein by reference.

### BACKGROUND OF THE INVENTION

1. Field of the Invention

The present invention relates to a mobile terminal and a method for operating the same and, more particularly, to a mobile terminal capable of conveniently setting a privacy protection function and, more particularly, a lock function and efficiently utilizing various privacy protection functions, and a method for operating the same.

2. Description of the Related Art

A mobile terminal is a portable device having at least one of a function for performing voice and video communication, a function for inputting and outputting information, and a function for storing data. Such a mobile terminal has complicated functions such as photographing of photos, capturing of moving images, playback of music files or moving image files, reception of games or broadcasts, or wireless Internet and has been transformed into a multimedia player, as the functions thereof have been diversified.

New attempts have been variously given to the mobile terminal implementing a multimedia player function through hardware or software in order to implement complex functions. For example, there is a user interface environment for enabling a user to easily and conveniently search for or select a function.

### SUMMARY OF THE INVENTION

Therefore, the present invention has been made in view of the above problems, and it is an object of the present invention to provide a mobile terminal capable of enabling a user to easily and conveniently utilize a function, and a method for operating the same.

It is another object of the present invention to provide a mobile terminal capable of rapidly performing predetermined operation based on how a user grips the mobile terminal satisfying establishment standard, and a method for operating the same.

It is another object of the present invention to provide a method for operating a remote controller and an image display apparatus, which is capable of easily and rapidly capturing a screen.

In accordance with an aspect of the present invention, the above and other objects can be accomplished by the provision of a method for operating a mobile terminal, including detecting whether pressure is applied via a plurality of sensors, detecting the level of the pressure, entering a call recording mode for recording content of a telephone call if the detected level of the pressure is greater than a reference value and the telephone call is established, and entering a memo mode if the detected level of the pressure is greater than the reference value and the telephone call is not established.

In accordance with another aspect of the present invention, there is provided a method for operating a mobile terminal, including displaying a predetermined image on a display, detecting whether pressure is applied via a plurality of sensors, detecting the level of the pressure, and performing corresponding operation based on attributes of the image if the detected level of the pressure is greater than a reference value.

In accordance with another aspect of the present invention, there is provided a mobile terminal including a plurality of pressure sensors for detecting whether pressure is applied and detecting the level of the pressure, and a controller for controlling entrance to a call recording mode for recording content of a telephone call if the detected level of the pressure is greater than a reference value and the telephone call is established and entrance to a memo mode if the detected level of the pressure is greater than the reference value and the telephone call is not established.

In accordance with another aspect of the present invention, there is provided a mobile terminal including a display for displaying a predetermined image, a plurality of pressure sensors for detecting whether pressure is applied and detecting the level of the pressure, and a controller for controlling performance of corresponding operation based on attributes of the image if the detected level of the pressure is greater than a reference value.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the configuration of a mobile terminal according to an embodiment of the present invention;

FIG. 2 is a perspective view of a mobile terminal according to an embodiment of the present invention when viewed from a front side thereof;

FIG. 3 is a perspective view of a mobile terminal when viewed from a rear side thereof;

FIG. 4 is a flowchart illustrating a method for operating a mobile terminal according to an embodiment of the present invention;

FIG. 5 is a flowchart illustrating a method for operating a mobile terminal according to an embodiment of the present invention;

FIGS. 6 to 16B are views referred to for describing a method for operating a mobile terminal according to various embodiments of the present invention;

FIG. 17 is a flowchart illustrating a method for operating a remote controller and an image display apparatus according to an embodiment of the present invention;

FIGS. 18 to 22 are views referred to for describing a method for operating a remote controller and an image display apparatus according to various embodiments of the present invention;

FIG. 23A is a perspective view of a mobile terminal according to an embodiment of the present invention when viewed from a front side thereof;

FIG. 23B is a perspective view of a mobile terminal 2 when viewed from a rear side thereof;

FIGS. 24A to 30D are views referred to for describing a method for operating a mobile terminal according to various embodiments of the present invention; and

FIG. 31 is a flowchart illustrating a method for operating a mobile terminal according to an embodiment of the present invention.

### DETAILED DESCRIPTION OF THE PREFERRED EMBODIMENTS

Exemplary embodiments of the present invention will be described with reference to the attached drawings.

A mobile terminal described in the present specification includes a mobile phone, a smart phone, a laptop, a digital broadcast terminal, a personal digital assistant (PDA), a portable multimedia player (PMP), a camera, a navigation system, a tablet computer, an e-book terminal, etc. The terms “module” and “unit” attached to describe the names of components are used herein to help the understanding of the components and thus they should not be considered as having specific meanings or roles. Accordingly, the terms “module” and “unit” may be used interchangeably.

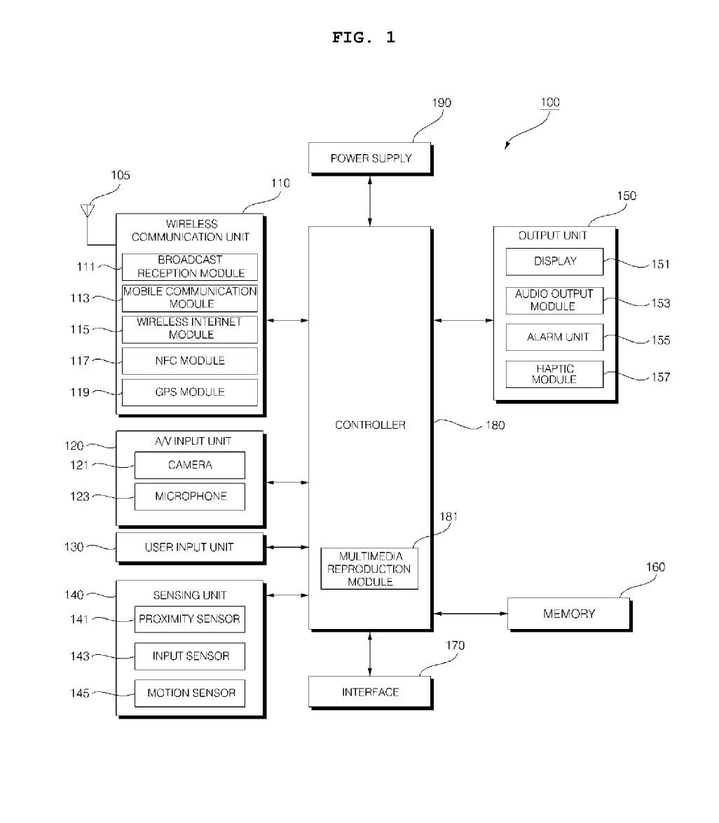

FIG. 1 is a block diagram showing the configuration of a mobile terminal according to an embodiment of the present invention. The components of the mobile terminal according to the embodiment of the present invention will be described with reference to FIG. 1.

Referring to FIG. 1, the mobile terminal 100 may include a wireless communication system 110, an audio/video (A/V) input unit 120, a user input unit 130, a sensing unit 140, an output unit 150, a memory 160, an interface 170, a controller 180 and a power supply 190. Two or more components may be combined into one component or one component may be divided into two or more components, as necessary.

The wireless communication unit 110 may include a broadcast reception module 111, a mobile communication module 113, a wireless Internet module 115, a near field communication (NFC) module 117, a global positioning system (GPS) module 119, etc.

The broadcast reception module 111 receives at least one of a broadcast signal and broadcast-related information from an external broadcast management server through a broadcast channel. The broadcast channel may include a satellite channel and a terrestrial channel. The broadcast management server may refer to a server for generating and transmitting at least one of a broadcast signal and broadcast-related information or a server for receiving and transmitting at least one of a previously generated broadcast signal and broadcast-related information to a terminal.

The broadcast signal may include not only a TV broadcast signal, a radio broadcast signal and a data broadcast signal but also a broadcast signal obtained by combining a TV broadcast signal or a radio broadcast signal with a data broadcast signal. The broadcast-related information may refer to information related to a broadcast channel, a broadcast program or a broadcast service provider. The broadcast-related information may be provided via a mobile communication network and, in this case, may be received by the mobile communication module 113. The broadcast-related information may have various formats.

The broadcast reception module 111 receives a broadcast signal using various broadcast systems. More particularly, the broadcast reception module 111 may receive a digital broadcast signal using a digital broadcast system such as digital multimedia broadcasting-terrestrial (DMB-T), digital multimedia broadcasting-satellite (DMB-S), Media Forward Link Only (MediaFLO), digital video broadcast-handheld (DVB-H) or integrated services digital broadcast-terrestrial (ISDB-T). The broadcast reception module 111 may be configured to suit not only a digital broadcast system but also all broadcast systems for providing broadcast signals. The broadcast signal and/or the broadcasted-related information received through the broadcast reception module 111 may be stored in the memory 160.

The mobile communication module 113 transmits or receives a wireless signal to or from at least one of a base station, an external terminal and a server over a mobile communication network. The wireless signal may include a voice call signal, a video call signal or various types of data associated with transmission and reception of a text/multimedia message.

The wireless Internet module 115 is an internal or external module for wireless Internet access which may be provided to the mobile terminal 100. As wireless Internet technologies, Wireless LAN (WLAN) (Wi-Fi), Wireless broadband (WiBro), World Interoperability for Microwave Access (WiMax) or High Speed Downlink Packet Access (HSDPA), etc. may be used.

The NFC module 117 may perform NFC. As NFC technologies, Bluetooth, Radio Frequency Identification (RFID), Infrared Data Association (IrDA), Ultra Wideband (UWB), ZigBee, etc. may be used.

The GPS module 119 may receive position information from a plurality of GPS satellites.

The A/V input unit 120 receives an audio signal or a video signal and may include a camera 121 and a microphone 123. The camera 121 processes a video frame of a still image or a moving image obtained by an image sensor in a video call mode or a photographing mode. The processed video frame may be displayed on the display 151.

The video frame processed by the camera 121 may be stored in the memory 160 or externally transmitted through the wireless communication unit 110. The number of cameras 121 may be two or more according to the configuration of the terminal.

The microphone 123 receives an external audio signal in a call mode, a recording mode or a voice recognition mode and converts the external audio signal into electrical audio data. The processed audio data may be converted into a format transmittable to a mobile communication base station through the mobile communication module 113 to be output in a call mode. The microphone 123 may use various noise elimination algorithms for eliminating noise generated in a process of receiving the external audio signal.

The user input unit 130 generates key input data enabling the user to control the operation of the terminal. The user input unit 130 may include a keypad, a dome switch, a touchpad (static pressure/static electrical), etc., which are capable of receiving a command or information by a push or touch operation of the user. The user input unit 130 may include a jog wheel for rotating a key, a joystick, a finger mouse, etc. In particular, if the touchpad and the display 151 have a layered structure, it may be called a touchscreen.

The sensing unit 140 detects a current state of the mobile terminal 100 such as whether the mobile terminal 100 is opened or closed, the position of the mobile terminal 100 and contact/non-contact of a user and generates a sensing signal for controlling the operation of the mobile terminal 100. For example, if the mobile terminal 100 is a slide phone, the sensing unit 140 may sense whether the slide phone is opened or closed. The sensing unit 140 may sense whether or not the power supply 190 supplies power or whether or not an external device is connected through the interface 170.

The sensing unit 140 may include a proximity sensor 141, a pressure sensor 143 and a motion sensor 145. The proximity sensor 141 detects presence/absence of an object which approaches the mobile terminal 100 or an object located in the vicinity of the mobile terminal 100 without mechanical contact. The proximity sensor 141 may detect an object approaching the mobile terminal using a change in an AC magnetic field, a change in a static magnetic field or a rate of change in capacitance. In addition, the proximity sensor may detect which surface of the mobile terminal is gripped by a user. The number of proximity sensors 141 may be two or more according to the configuration of the terminal.

The pressure sensor 143 may detect whether pressure is applied to the mobile terminal 100 or the level of the pressure. The pressure sensor 143 may be mounted at a position at which pressure applied to the mobile terminal 100 needs to be detected according to a use environment.

If the pressure sensor 143 is mounted in the display 151, touch input through the display 151 and pressure touch input having pressure greater than that of the touch input may be identified according to the signal output from the pressure sensor 143. The level of the pressure applied to the display 151 may be detected according to the signal output from the pressure sensor 143 upon pressure touch input.

If the pressure sensor 143 is mounted at an edge of the mobile terminal 100, pressure may be detected to detect which surface of the mobile terminal 100 the user grips.

The motion sensor 145 may sense motion or position of the mobile terminal 100 using an acceleration sensor, a gyroscopic sensor, etc. In particular, as the acceleration sensor which may be used in the motion sensor 145, a sensor for converting an acceleration change in one direction into an electrical signal has been widely used with development of a micro-electromechanical system (MEMS).

The acceleration sensor may include various sensors such as an acceleration sensor which may be mounted in an airbag system of a vehicle to measure acceleration having a large value used to detect collision and an acceleration sensor which may measure acceleration having a small value used as an input means of a game console. Two-axis or three-axis acceleration sensors may be mounted in one package or only a Z-axis acceleration sensor may be mounted according to use environment. Accordingly, for certain reasons, if a X-axis or Y-axis acceleration sensor is used instead of the Z-axis acceleration sensor, the acceleration sensor may be mounted on a main board in an erect state using a separate board piece.

The gyroscopic sensor measures an angular speed and senses a direction in which the mobile terminal rotates from a reference direction.

The sensing unit 140 may include sensors for user authentication. For example, if user authentication is performed using biometric data, a sensor for sensing temperature, fingerprint, iris or face may be included and a necessary sensor may be included according to a user authentication method set in the mobile terminal 100.

The output unit 150 outputs an audio signal, a video signal or an alarm signal. The output unit 150 may include a display 151, an audio output module 153, an alarm unit 155 and a haptic module 157.

The display 151 displays information processed by the mobile terminal 100. For example, if the mobile terminal 100 is in a call mode, the display displays a user interface (UI) or a graphical user interface (GUI) related to a call. If the mobile terminal 100 is in a video call mode or a photographing mode, the display may individually or simultaneously display the photographed or received images and display a UI and a GUI.

As described above, if the display 151 and the touchpad have the layered structure to configure the touchscreen, the display 151 can be used not only as an output device but also as an input device for inputting information via touch.

If the display 151 is a touchscreen, the display may include a touchscreen panel, a touchscreen panel controller, etc. In this case, the touchscreen panel is a transparent panel attached to the outside of the display and may be connected to an internal bus of the mobile terminal 100. The touchscreen panel receives a touch input and sends a signal corresponding to the touch input to the touchscreen panel controller. The touchscreen panel controller processes the received signal, transmits data corresponding to the signal to the controller 180, and enables the controller 180 to detect whether the touch input is received or which portion of the touchscreen is touched.

The display 151 may include e-paper. The e-paper may be a reflection type display and has high resolution, wide viewing angle and excellent visual characteristics due to a bright white background, similarly to paper and ink. The e-paper may be implemented on a certain board such as plastic, metal, or paper, an image is maintained even after power is turned off, and the lifespan of the battery of the mobile terminal 100 may be increased because a backlight power source is not used. As the e-paper, a semispherical twisted ball charged with electric charges, electrophoresis, a microcapsule, etc. may be used.

The display 151 may include at least one of a liquid crystal display, a thin film transistor-liquid crystal display, an organic light emitting diode, a flexible display and a 3-dimensional (3D) display. The number of displays 151 may be two or more according to implementations of the mobile terminal 100. For example, the mobile terminal 100 may include both an external display (not shown) and an internal display (not shown).

The audio output module 153 may output audio data received from the wireless communication module 110 or stored in the memory 160 in call signal reception, a call mode, a recording mode, a voice recognition mode or a broadcast reception mode. The audio output module 153 outputs an audio signal associated with the functions performed by the mobile terminal 100, such as call signal reception sound or message reception sound. The audio output module 153 may include a speaker, a buzzer, etc.

The alarm unit 155 outputs a signal notifying the user that an event has occurred in the mobile terminal 100. Examples of the event which has occurred in the mobile terminal 100 include call signal reception, message reception, key signal input, etc. The alarm unit 155 outputs a signal notifying the user of the occurrence of an event in the other form in addition to an audio or video signal. For example, the alarm unit may output the signal in the form of vibrations. If a call signal or a message is received, the alarm unit 155 may output a signal notifying the user that the call signal or the message has been received. If a key signal is received, the alarm unit 155 may output a signal as a feedback signal of the key signal. The user may recognize occurrence of the event through the signal output from the alarm unit 155. The signal notifying the user that the event has occurred in the mobile terminal 100 may be output through the display 151 or the audio output module 153.

The haptic module 157 generates a variety of tactile effects that the user can feel. A typical example of the tactile effect generated by the haptic module 157 is vibration. If the haptic module 157 generates vibrations as a tactile effect, the intensity and pattern of the vibrations generated by the haptic module 157 may be changed and different vibrations may be combined and output or may be sequentially output.

The haptic module 157 may generate a variety of tactile effects such as an effect due to stimulus through arrangement of pins which vertically move with respect to a contact skin surface, an effect due to stimulus through air ejection force or absorption force through an ejection hole and an absorption hole, an effect due to stimulus through contact of an electrode, an effect due to stimulus using electrostatic force, or an effect due to cold and warmth using a heat absorption or heating element. The haptic module 157 may deliver the tactile effect through direct contact or enable the user to feel the tactile effect through kinaesthesia of a finger or arm of the user. The number of haptic modules 157 may be two or more according to the configuration of the mobile terminal 100.

The memory 160 may store a program for processing and control of the controller 180 and may temporarily store input or output data (for example, a phonebook, messages, audio, still images, and moving images).

The memory 160 may include at least one of a flash memory type, hard disk type, multimedia card micro type or card type memory (e.g., an SD or XD memory, etc.), a RAM and a ROM. The mobile terminal 100 may manage a web storage for performing a storage function of the memory 150 over the Internet.

The interface 170 serves as an interface with all external devices connected to the mobile terminal 100. Examples of the external device connected to the mobile terminal 100 include a wired/wireless headset, an external charger, a wired/wireless data port, a card socket such as a memory card, a subscriber identification module (SIM) card or a user identity module (UIM) card, an audio input/output (I/O) terminal, a video I/O terminal, and an earphone. The interface 170 may receive data from an external device or receive power and transmit power to the components of the mobile terminal 100 or transmit data of the mobile terminal 100 to an external device.

The interface 170 may become a passage through which power is supplied from an external cradle to the mobile terminal 100 when the mobile terminal is connected to the external cradle or a passage through which a variety of command signals received from the cradle by the user is delivered to the mobile terminal 100.

The controller 180 controls the operations of the units and controls the overall operation of the mobile terminal 100. For example, the controller performs control and processing associated with a voice call, data communication, a video call, etc. The controller 180 may include a multimedia reproduction module 181 for multimedia reproduction. The multimedia reproduction module 181 may be implemented in the controller 180 in hardware form or may be implemented in software form separately from the controller 180.

The power supply 190 receives external power or internal power and supplies power required for operation to each component under control of the controller 180.

The mobile terminal 100 having the above configuration includes a wired/wireless communication system and a satellite based communication system so as to operate in a communication system for transmitting data through a frame or packet.

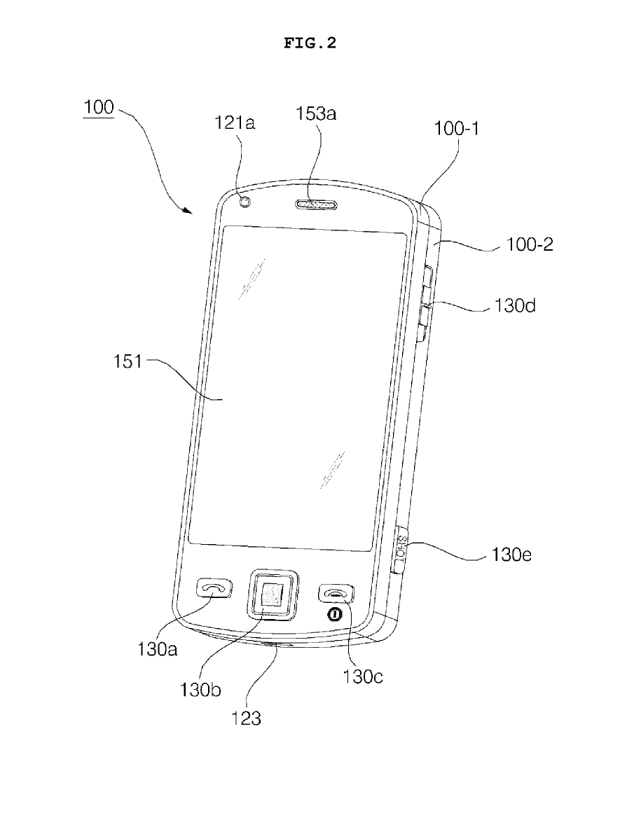

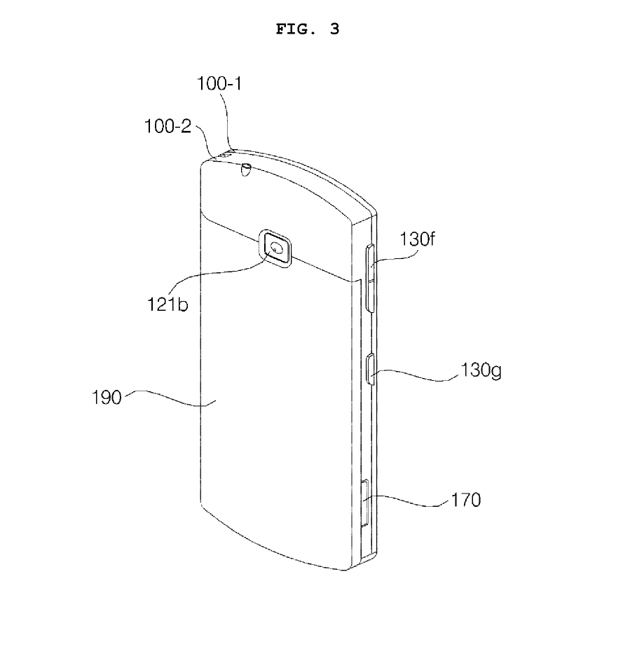

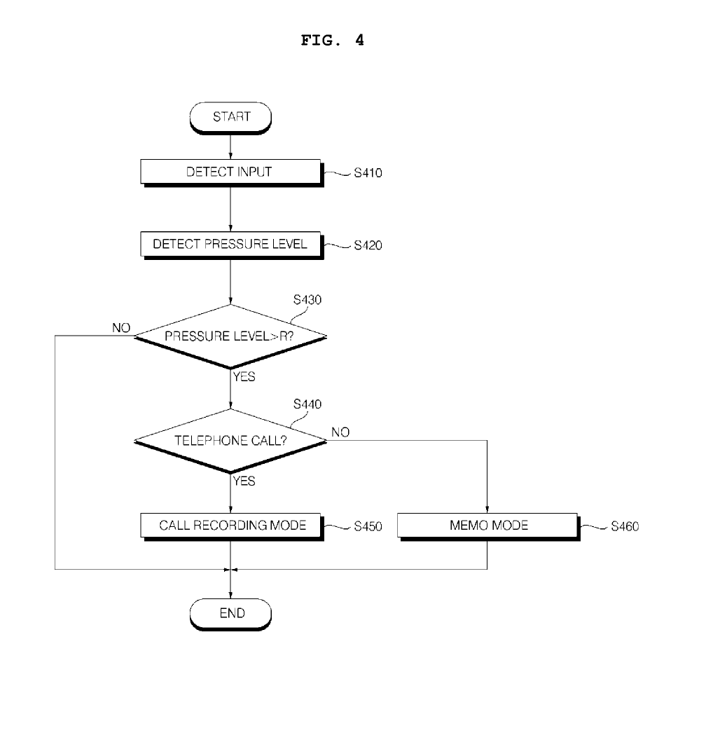

FIG. 2 is a perspective view of a mobile terminal according to an embodiment of the present invention when viewed from a front side thereof, and FIG. 3 is a perspective view of the mobile terminal shown in FIG. 2 when viewed from a rear side thereof. Hereinafter, the appearance of the mobile terminal according to the present invention will be described with reference to FIGS. 2 and 3. Hereinafter, for convenience, among folder type, bar type, swing type and slider type mobile terminals, a bar type mobile terminal including a touchscreen at a front side thereof will be described. However, the present invention is not limited to the bar type mobile terminal and is applicable to all types of mobile terminals including the above-described types.

Referring to FIG. 2, a case forming the appearance of the mobile terminal 100 includes a front case 100-1 and a rear case 100-2. In a space formed by the front case 100-1 and the rear case 100-2, various electronic parts are mounted.

In a main body, that is, in the front case 100-1, a display 151, a first audio output module 153a, a first camera 121a and first to third user input units 130a, 130b and 130c are arranged. A fourth user input unit 130d, a fifth user input unit 130e and a microphone 123 may be arranged on the side surface of the rear case 100-2.

The display 151 and a touch pad have the layered structure to configure the touchscreen so as to enable the user to input information through touch.

The first audio output module 153a may be implemented in the form of a receiver or a speaker. The first camera 121a may be implemented in a form suitable for photographing an image of the user or capturing moving image of the user. The microphone 123 may be implemented in a form suitable for receiving user voice or other sounds.

The first to fifth user input units 130a, 130b, 130c, 130d and 130e and the below-described sixth and seventh user input units 130f and 130g may be collectively referred to as a user input unit 130 and any tactile manner for operating the mobile terminal while providing a tactile effect to the user may be employed.

For example, the user input unit 130 may be implemented in the form of a dome switch or a touch pad which is capable of receiving a command or information by a push or touch operation of the user or in the form of a jog wheel for rotating a key, or a joystick. The first to third user input units 130a, 130b and 130c are used to input a command such as start, end, scroll, etc. and the fourth user input unit 130d is used to input choice of an operation mode. The fifth user input unit 130e may function as a hot key for activating a special function of the mobile terminal 100.

Referring to FIG. 3, a second camera 121b may be mounted on a rear surface of the rear case 100-2 and the sixth and seventh user input units 130f and 130g and an interface 170 are disposed on a side surface of the rear case 100-2.

The second camera 121b has a photographing direction substantially opposite to that of the first camera 121a and may have a different resolution than the first camera 121a. A flash (not shown) and a mirror (not shown) may be further provided near the second camera 121b. Another camera may further be mounted near the second camera 121b to be used to capture a three-dimensional image.

The flash illuminates a subject when the subject is captured using the second camera 121b. The mirror enables the user to view his/her face when the picture of the user is taken by himself/herself using the second camera 121b (self photographing).

In the rear case 100-2, a second audio output module (not shown) may further be included. The second audio output module may perform a stereo function along with the first audio output module 153a and may be used to place a call in a speakerphone mode.

The interface 170 may be used as a passage through which data is exchanged with an external device. A broadcast signal reception antenna (not shown) may be provided in one of the front case 100-1 and the rear case 100-2 in addition to an antenna for telephone call. The antenna may be retractable from the rear case 100-2.

A power supply 190 for supplying power to the mobile terminal 100 may be mounted at the side of the rear case 100-2. The power supply 190 is, for example, a rechargeable battery and may be detachably coupled to the rear case 100-2, for charging.

Although the second camera 121b is mounted on the rear case 100-2 in the above description, the present invention is not limited thereto. Alternatively, the second camera 121b may not be separately included, but the first camera 121a may be rotatably formed to photograph a subject located in the photographing direction of the second camera 121b.

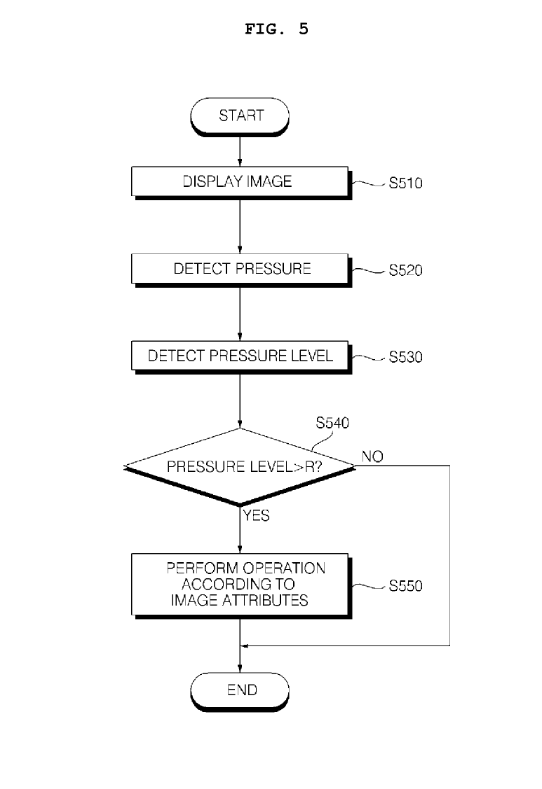

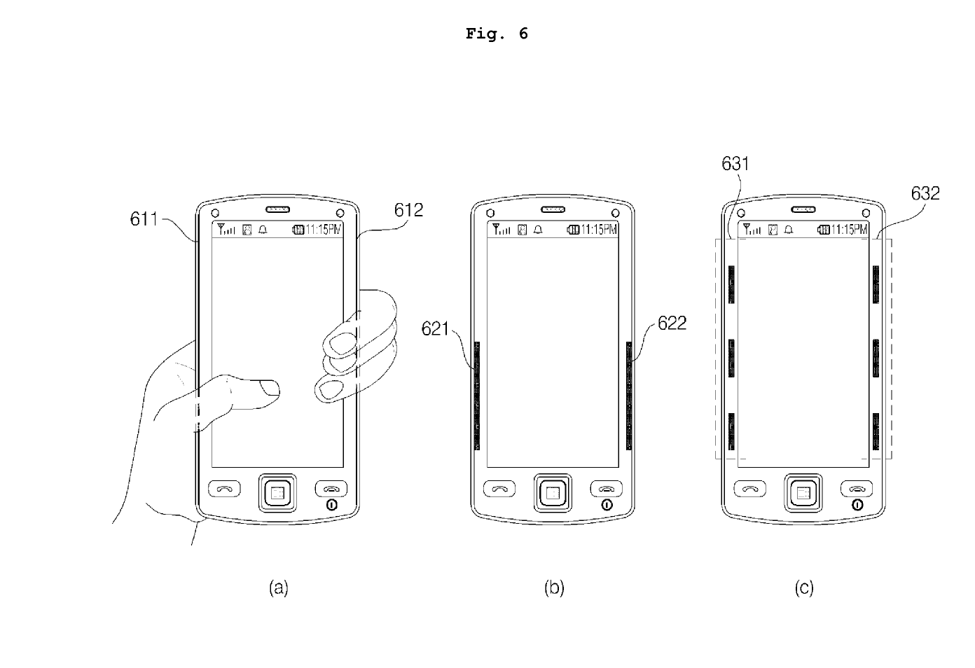

FIGS. 4 and 5 are flowcharts illustrating a method for operating a mobile terminal according to embodiments of the present invention, and FIGS. 6 to 16B are views referred to for describing a method for operating a mobile terminal according to various embodiments of the present invention.

Referring to FIG. 4, in the method for operating the mobile terminal according to one embodiment of the present invention, first, whether pressure is applied is detected via a plurality of sensors (S410) and the level of the pressure may be detected if the pressure is applied (S420).

For example, the mobile terminal according to the present invention may include a pressure sensor for sensing pressure applied to a body and the pressure sensor may be placed at a position at which pressure needs to be sensed. The pressure sensor may detect whether pressure is applied and the level of the applied pressure and output the detected result to the controller 180.

The controller 180 compares the detected level of the pressure with a predetermined reference value R (S430). If pressure greater than the predetermined reference value is detected, the controller 180 may determine that squeeze input for gripping the mobile terminal 100 with pressure greater than the reference value is received as a user's command for performing a predetermined operation.

If squeeze input of the user is detected, the controller 180 may perform operation based on a current operation state.

For example, the controller 180 may control entrance to a call recording mode for recording a telephone call (S450) if the detected level of the pressure exceeds the reference value and the telephone call is established upon squeeze input (S440).

The call recording mode(0 may be stored and played back in the format of wav, wma, ogg or mp3 according to a method of processing recorded data of the mobile terminal 100.

The controller 180 may control entrance to a memo mode if the detected level of the pressure is greater than the reference value and the telephone call is not established (S460).

That is, if the user grips the mobile terminal with pressure greater than the reference value in a state in which the telephone call is not established, the mobile terminal may enter the memo mode.

In one embodiment of the present invention, in step S460 of entering the memo mode, the mobile terminal enters a first memo mode for recording voice if the user's face approaches the mobile terminal and, otherwise, enters a second memo mode for capturing a screen and writing a memo on the captured image.

In this case, if the detected level of the pressure is greater than the reference value and a telephone call is not established, activation of the camera or the sensing unit may be further included.

The mobile terminal 100 according to one embodiment of the present invention further includes a detector for detecting whether the user's face approaches the mobile terminal. If the detected level of the pressure is greater than the reference value and a telephone call is not established, the controller 180 may control activation of the detector.

If it is detected that the user's face approaches the mobile terminal, the controller 180 may control entrance to the first memo mode for recording voice, that is, a memo recording mode.

Otherwise, the controller 180 may control entrance to the second memo mode for capturing a screen and writing a memo upon the captured image.

The detector for detecting whether the user's face approaches the mobile terminal may be at least one of a camera, a proximity sensor or luminance sensor.

In another embodiment, a step of displaying, on the display 151, a menu for selecting one of a first memo mode for recording voice and a second memo mode for capturing a screen and writing a memo on the captured image and a step of receiving input for one of the first memo mode and the second memo mode may be further included. In step S460 of entering the memo mode, the controller 180 may control entrance to the selected memo mode.

That is, the controller 180 may control recording of the content of the telephone call if the telephone call is established, and control display of the menu on the display 151 and performance of the memo mode selected by the user if the telephone call is not established.

In one embodiment of the present invention, a step of detecting a position at pressure is applied may be further included. In step S450 of entering the call recording mode or step S460 of entering the memo mode, if pressure greater than the reference value is applied to both opposite sides of the mobile terminal 100, the mobile terminal may enter the corresponding mode depending on whether the telephone call is established or not.

That is, the controller 180 may control entrance to the memo mode depending upon the operation state, such as whether the telephone call is established or not, only when application of pressure to both sides of the mobile terminal 100 is detected.

According to the embodiment of the present invention, if the detected pressure reaches the reference value, at least one of an audio effect and a vibration effect may be output so as to notify the user that the mobile terminal enters various memo modes.

Referring to FIG. 5, the method for operating the mobile terminal according to one embodiment of the present invention may include a step S510 of displaying a predetermined image (screen) on the display 151, a step S520 of detecting whether pressure is applied via a plurality of sensors, a step S530 of detecting the level of the pressure, a step S540 of determining whether the detected level of the pressure is greater than a reference value and a step S550 of performing corresponding operation based on attributes of the image if the detected level of the pressure is greater than the reference value.

The present embodiment is different from the embodiment of FIG. 4 in that the controller 180 does not control entrance to the memo mode by determining whether the telephone call is established or whether the user's face approaches the mobile terminal but performs operations according to the attributes of a last screen when or before pressure greater than the reference value is detected.

If the predetermined image (screen) is a lock screen, the controller 180 may control entrance to the voice recording mode (voice memo mode) for recording user voice in the step of performing the operation.

When the lock screen is displayed on the display 151, since the user does not yet perform specific operation using the mobile terminal 100, accurate determination of user intention is difficult.

In addition, since a telephone call to be recorded or an image to be captured is not present, the controller 180 may control rapid switching to the voice recording mode for recording voice if pressure greater than the reference value is detected in the lock screen state.

In addition, the user may set pressure greater than the reference value applied at a specific position of the mobile terminal 100 as unlock input and the controller 180 may simultaneously perform unlockings and mode switching without separate input.

If the predetermined screen is being used, step S550 of performing the operation may include capturing the predetermined screen and displaying a menu item for memo input to in some regions of the display 151.

When pressure greater than the reference value is detected when the user uses a predetermined service or function such as web surfing, album viewing, social network service, various settings, etc., the controller 180 may control capturing of a screen and display of memo tool menus on the display 151 such that the user inputs a memo on the captured image.

In the present embodiment, a step of receiving memo input of the user on the captured image and a step of storing content of the input memo and the captured image in the memory 160 may be further included. That is, the controller 180 may merge and store the user's memo and the captured image in the memory 160.

If the predetermined screen is a call related screen, step S550 of performing the operation may include entrance to the call recording mode for recording the content of the telephone call. Here, the call recording mode may be completed upon termination of the telephone call or when a user termination command is input.

The method for operating the mobile terminal according to the embodiment of the present invention may further include a step of storing the content of a telephone call when a telephone call begins and a step of merging and storing content recorded in the call recording mode and content stored during a predetermined time before entering the call recording mode if the call recording mode is terminated.

That is, the controller 180 may temporarily store the content of a telephone call without user command when a telephone call begins and delete the temporarily recorded data if a recording command of the user is not received.

In addition, when squeeze input is detected during the telephone call, the controller 180 may merge and store at least a part of the temporarily recorded data before squeeze input and the recorded data after the squeeze input. Thus, it is possible to record a telephone call as desired by the user.

The method for operating the mobile terminal according to the embodiment of the present invention may further include a step of detecting a position at which pressure is applied. Step S550 of performing the operation may include performing the corresponding operation if pressure is applied to both opposite sides of the mobile terminal 100. That is, the user may set and use the position at which pressure is applied, as a condition for performing the operation.

The method for operating the mobile terminal according to the embodiment of the present invention may further include a step of outputting at least one of an audio effect and a vibration effect if the detected pressure reaches the reference value.

FIG. 6 shows various arrangements of a pressure sensor for detecting grip pressure applied to the mobile terminal.

The pressure sensor 143 may detect whether pressure is applied to the mobile terminal 100 and the level of the pressure. Accordingly, only when the detected level of the pressure is equal to or greater than a predetermined value, predetermined operation may be set to be performed. Accordingly, it is possible to prevent malfunction while rapidly performing the operation.

The pressure sensor 143 may be mounted at a position of the mobile terminal 100 where pressure needs to be detected according to use environment.

The pressure sensor 143 may be placed at an edge of the mobile terminal 100.

In addition, the pressure sensor may be placed in a region of the mobile terminal 100, which may be gripped by the user, of the edge of the mobile terminal 100, e.g., on left and right sides 611 and 622 of the mobile terminal 100, as shown in FIG. 6(a). Alternatively, the pressure sensor may be placed on any one of both sides of the mobile terminal 100.

Alternatively, as shown in FIG. 6(b), pressure sensors 621 and 622 may be placed in some regions, e.g., lower regions, of both sides of the mobile terminal.

Alternatively, as shown in FIG. 6(c), pressure sensors 631 and 632 may be placed at right and left sides of the mobile terminal in a state in which a plurality of sensors are separated from each other in the form of a line.

As described above with reference to FIG. 4, according to the embodiment of the present invention, if squeeze operation is detected during the telephone call, it is possible to automatically record the content of the telephone call and to merge temporarily stored data for several seconds before recording the content of the telephone call to record the content of the telephone call.

If the user's face approaches the mobile terminal 100 after the squeeze operation, the mobile terminal enters a voice memo. Otherwise, the mobile terminal may enter a normal memo mode or an image memo mode for writing a memo on a captured image.

If the detected level of the pressure exceeds the reference value upon the squeeze operation and the telephone call is not established, the controller 180 may activate the camera or the sensing unit.

For example, the camera 121 may be activated upon the squeeze operation for facial recognition and angle detection. Alternatively, whether the user's face approaches the mobile terminal may be determined using the proximity sensor 141 or using the luminance sensor. For example, if it is determined that luminance is decreased using the luminance sensor, it may be recognized that the user's face approaches the mobile terminal.

The menu may be displayed on the display 151 to perform operation selected by the user.

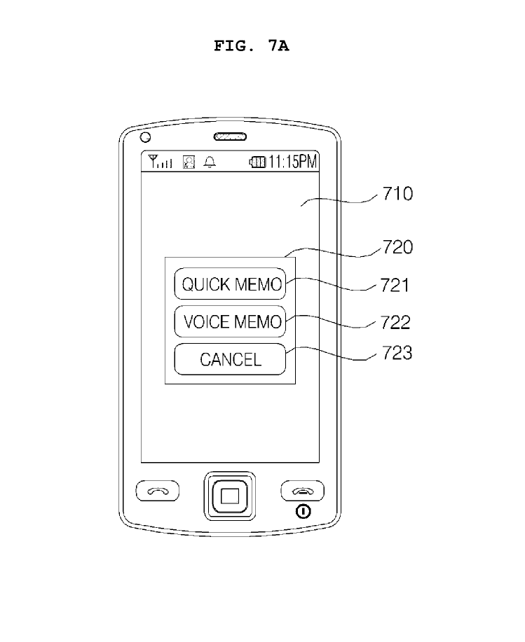

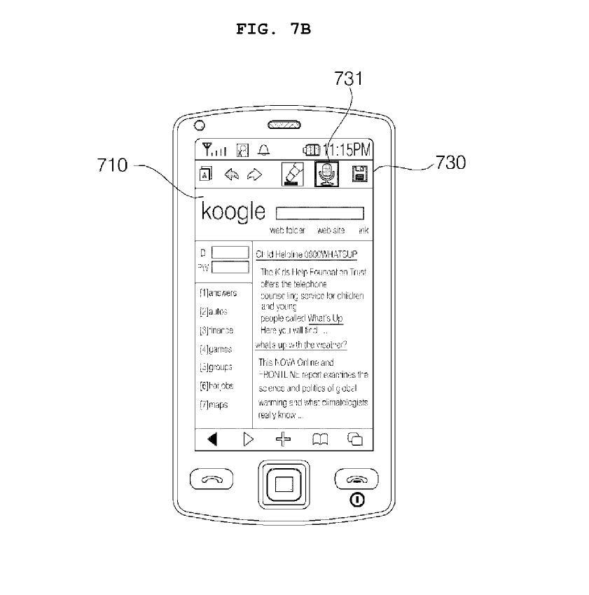

If the squeeze operation is performed during a telephone call, the content of the telephone call is recorded. If the squeeze operation is performed in the other state, as shown in FIG. 7A, a menu including a memo item 721, a voice memo item 722 and a cancel item 723 may be displayed in at least some regions of a predetermined screen 710 of the display 151.

If the user selects the memo item 720 or the voice memo item 722, the controller 180 may control performance of a memo function corresponding thereto.

For example, if the user selects the memo item 720, as shown in FIG. 7B, a predetermined screen 710 may be captured and a tool menu item 730 for inputting a memo may be displayed in a predetermined region of the display 151. The user may freely input the memo using the items of the tool menu item 730.

According to the embodiment of the present invention, the tool menu item 730 may further include a recording icon 731. If the user selects the recording icon 731, voice may be set to be recorded on a memo screen.

According to one embodiment of the present invention, the controller 180 may determine operation to be performed based on attributes of the screen displayed on the display 151.

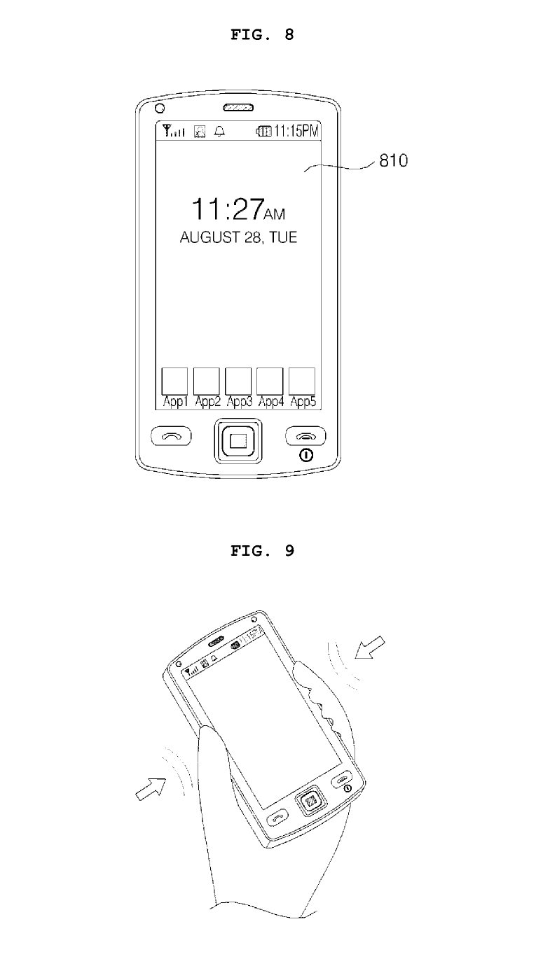

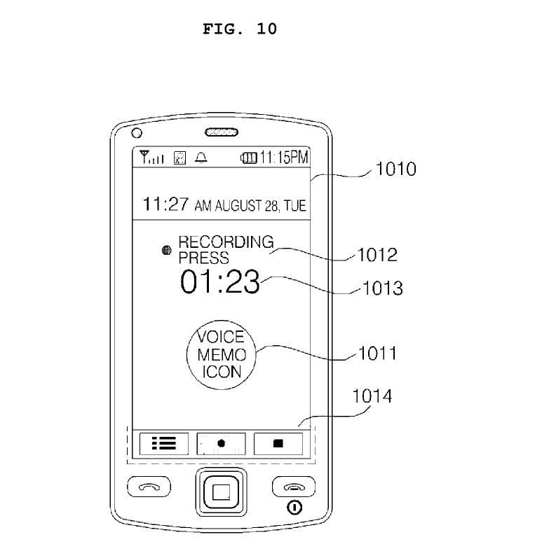

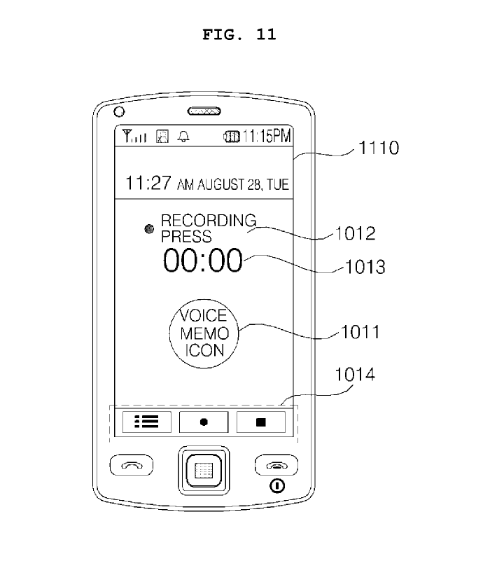

Referring to FIGS. 8 to 10, if the user performs the squeeze operation for gripping the mobile terminal 100 as shown in FIG. 9 with pressure greater than the reference value in a state in which a lock screen 810 is displayed on the display 151 as shown in FIG. 8, the controller 180 may control entrance to the voice recording mode as shown in FIG. 10 (voice memo mode).

The controller 180 outputs a vibration or audio effect if predetermined pressure is reached, thereby providing feedback to the user.

A screen 1010 in the voice recording mode may include at least one of an icon 1011 indicating a voice recording mode, a state item 1012 indicating a recording state or help, recording time information 1013 and a recording related menu 1014.

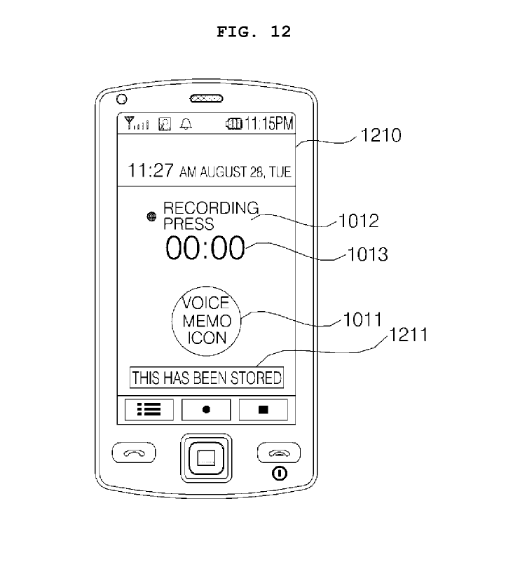

FIG. 10 shows a screen 1010 when entering the voice recording mode, FIG. 11 shows a screen 1110 when recording is being performed, and FIG. 12 shows a screen when terminating recording. The voice recording mode screen of the present invention is not limited thereto.

When the user selects a recording button from the recording related menu 1014, the mobile terminal 100 starts recording.

Once recording starts, as shown in FIG. 11, the state item 1012 indicates that recording is being performed and the recording time information 1013 may display a recording time.

When the user selects an end button from the recording related menu 1014, the mobile terminal 100 may end recording and store recorded data in the memory 160.

If recording has ended, as shown in FIG. 12, the recording time information 1013 may be initialized and a message indicating the end and storage state may be displayed in a popup form for a predetermined time. The message 1211 may be displayed for a predetermined time and then a file name and a playback button of recorded data may be displayed.

Alternatively, content related to the state item 1012 may be displayed without displaying a separate popup message 1211.

The user may set pressure greater than the reference value applied at a specific position of the mobile terminal 100 as unlock input and the controller 180 may unlock a lock screen without inputting a separate password to enter the recording mode.

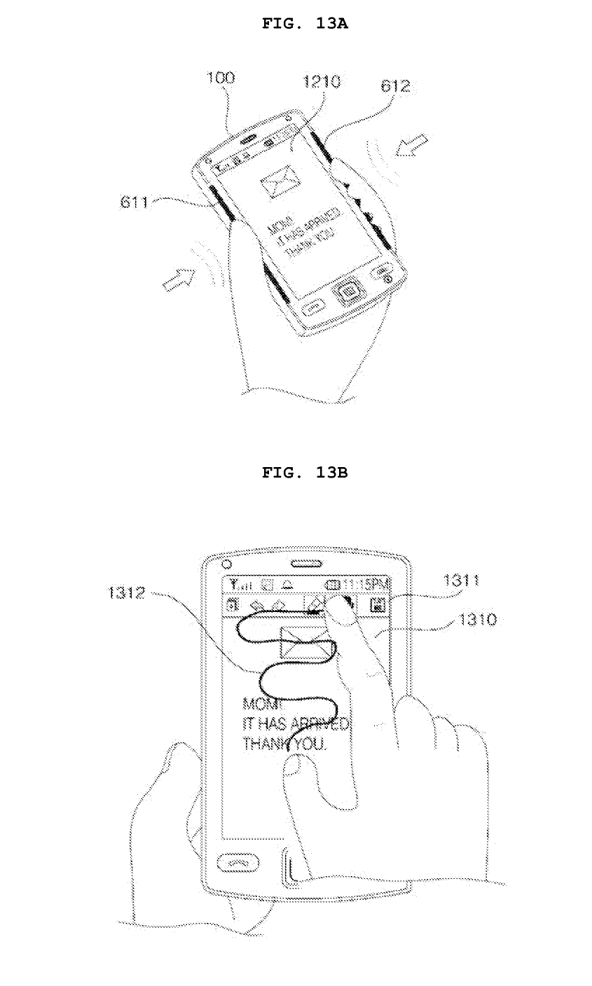

As shown in FIG. 13(a), if squeeze input is detected on a screen 1310 which is being used, the controller 180 may output vibration and/or sound feedback and capture the screen 1310.

In addition, the captured image 1310 and a tool menu item for inputting a memo may be displayed on the display 151 as shown in FIG. 13(b).

Alternatively, the captured image 1310 may be first displayed on the display 151 and then the menu item 1311 may be sequentially displayed on the screen if the user performs the squeeze operation again.

If the user inputs a memo 1312 on the captured screen and selects storage, the memo input is terminated and the image 1311 and the memo 1312 are stored.

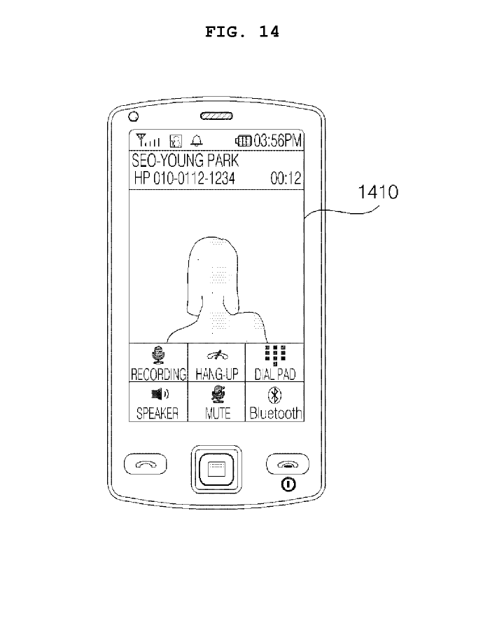

FIGS. 14 to 16B show examples upon telephone call.

As shown in FIG. 14, a predetermined screen 1410 is displayed on the display 151 upon telephone call. The telephone call screen 1410 may be set to disappear when a predetermined time has elapsed after a telephone call begins.

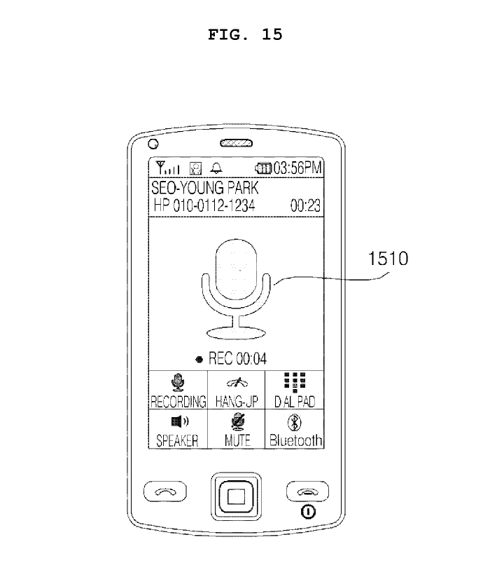

If the squeeze operation is detected during the telephone call, the controller 180 enters the call recording mode and automatically starts recording. An icon 1510 indicating that recording is being performed may be displayed on the display 151 as shown in FIG. 15.

Even in this case, when predetermined pressure is reached, a vibration and/or sound feedback may be output.

Voice may be automatically recorded when the telephone call begins and may be merged and stored with data recorded for a predetermined time, e.g., 5 seconds before the user performs the squeeze input.

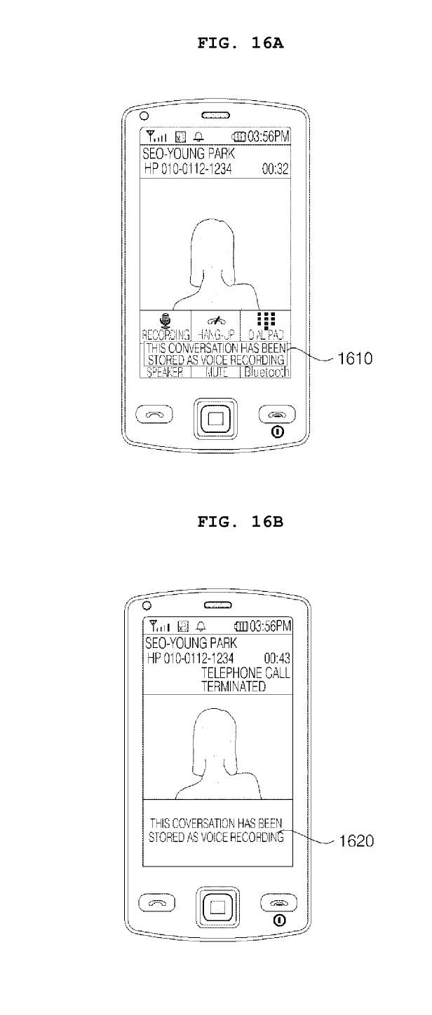

If the user presses a stop button, the controller 180 may terminate recording of the content of the telephone call and automatically store the content. In addition, the controller 180 may display a message 1610 indicating that the content has been stored on the display 151 as shown in FIG. 16A.

Alternatively, the controller 180 may terminate recording when a telephone call is terminated and automatically store the content. Even in this case, a message 1620 indicating that the content has been stored may be displayed on the display 151 as shown in FIG. 16B.

The above-described embodiments may be used for other handheld apparatuses in addition to the mobile terminal.

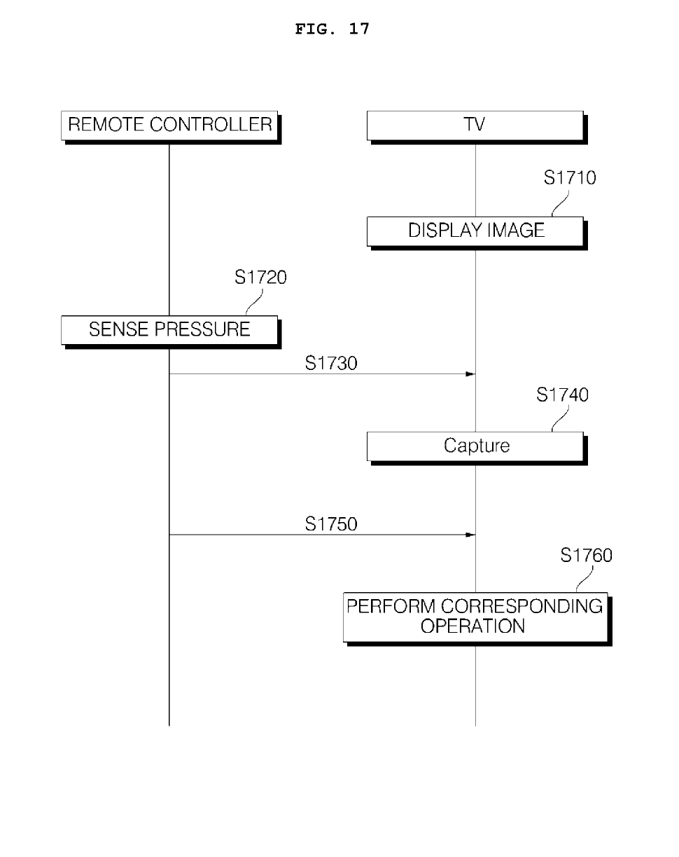

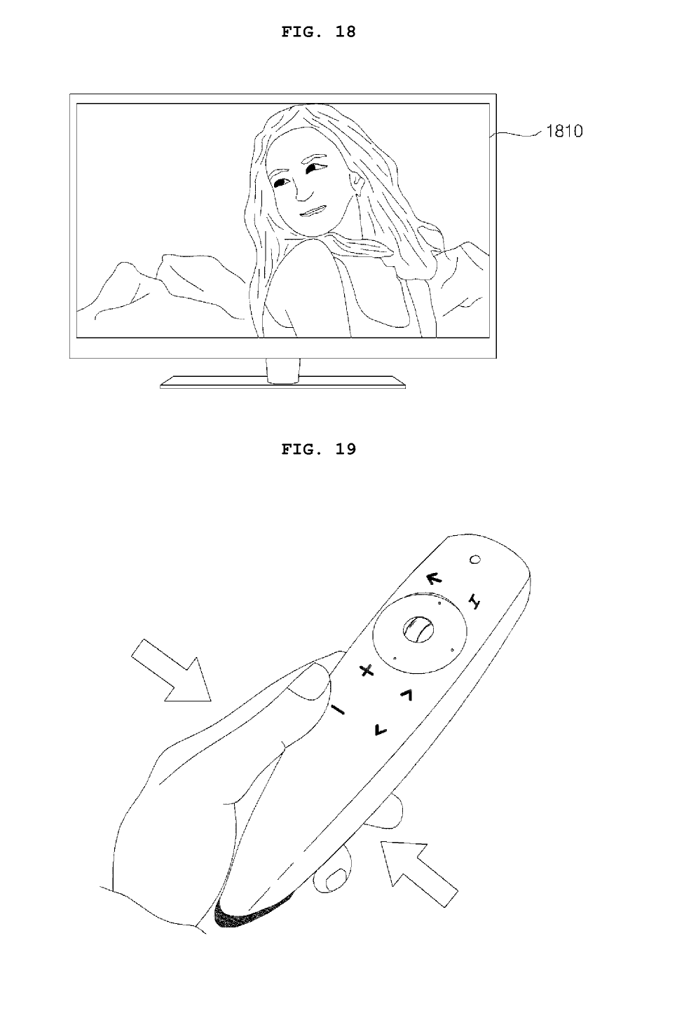

FIG. 17 is a flowchart illustrating a method for operating a remote controller and an image display apparatus according to an embodiment of the present invention, and FIGS. 18 to 22 are views referred to for describing a method for operating a remote controller and an image display apparatus according to various embodiments of the present invention.

Referring to the figures, first, the image display apparatus displays an image 1810 of a predetermined channel or other content as shown in FIG. 18 (S1710).

The remote controller may include a plurality of pressure sensors for sensing pressure. If the user wishes to capture the image while viewing the image 1810, as shown in FIG. 19, the user may perform squeeze operation for gripping the remote controller with pressure greater than a reference value (S1720).

If pressure satisfying a predetermined squeeze operation is detected (S1720), the remote controller may transmit a capture command signal to the image display apparatus (S1730).

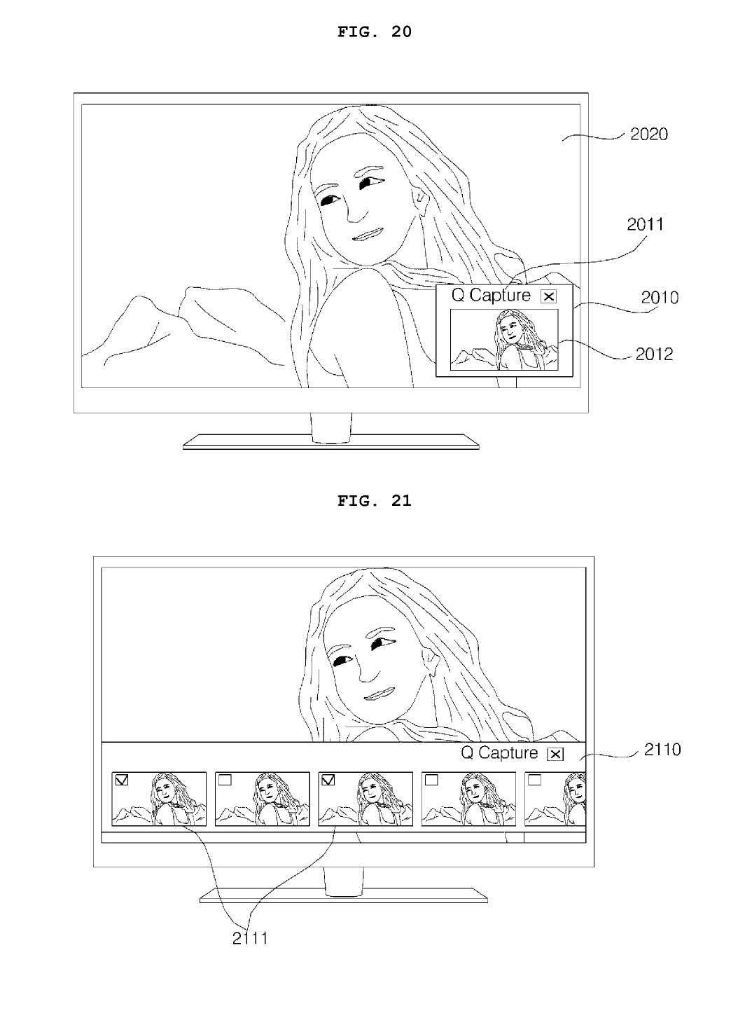

The image display apparatus may capture a predetermined image 2020 and display a capture related object 2010 as shown in FIG. 20 (S1740).

The capture related object 2010 may include text or an icon 2011 indicating capture, a thumbnail image 2012 of a captured image, a capture function related menu item, etc.

In case of a moving image, if the user performs the squeeze operation, a viewed image may be recorded using a DVR function or a predetermined image may be temporarily stored and then be recorded for several seconds before the squeeze operation is performed.

Thereafter, when the user manipulates the remote controller and transmits a command signal (S1750), the image display apparatus may perform corresponding operation (S1760).

When the user squeezes the remote controller, an image may be captured and, at the same time, a capture icon may be displayed on the screen. The user may select a menu along with the capture icon. The captured image 2012 or a screen 2110 including several images captured via menu selection may be displayed as shown in FIG. 21.

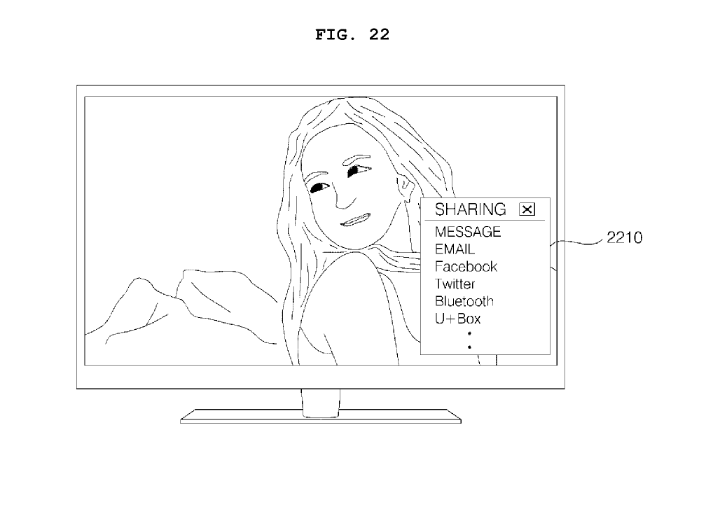

The user may select and edit predetermined images 2111 from among the captured images. Alternatively, the user may select sharing or uploading. A sharing screen 2210 including various sharing items such as a message, an email, a social network service, a memory and a server may be displayed in popup form during a predetermined time as shown in FIG. 22.

If additional user input is not received during a predetermined time when the capture related object 2010 is displayed, one captured image may be automatically stored and closed. Alternatively, even when an exit item is selected, the captured image may be stored and closed.

In addition, when the user continuously performs the squeeze operation, continuous capture is possible.

In the present invention, content which is emotionally desired to be recorded may be captured via a squeeze gesture of a user.

An appropriate capture format may be easily and immediately used according to circumstance. For example, audio may be recorded and an image may be captured or a moving image may be recorded. In addition, the screen may be captured without change and a memo may be further input and stored on the captured image.

Even in case of a TV, screen capture of a live broadcast may be performed for a predetermined time and may be easily shared.

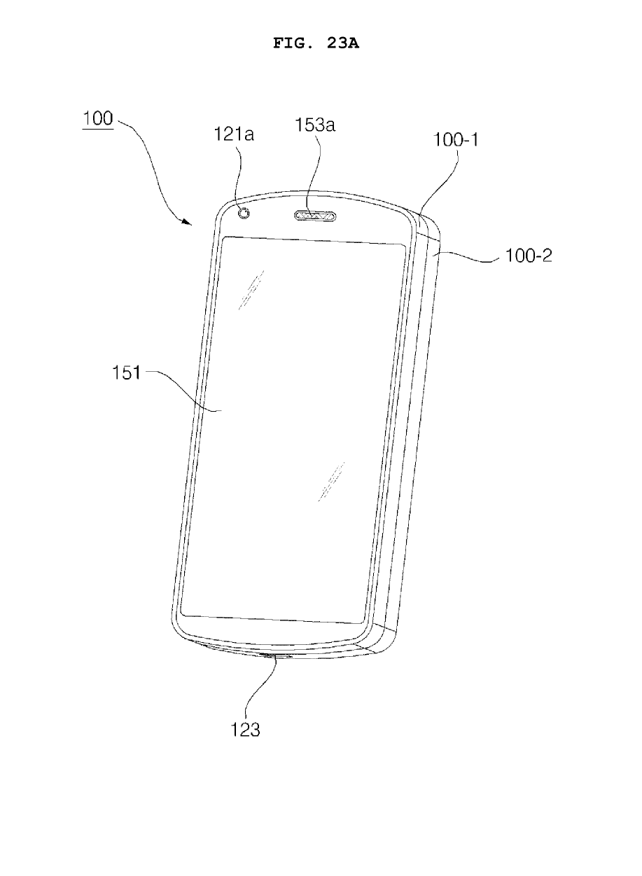

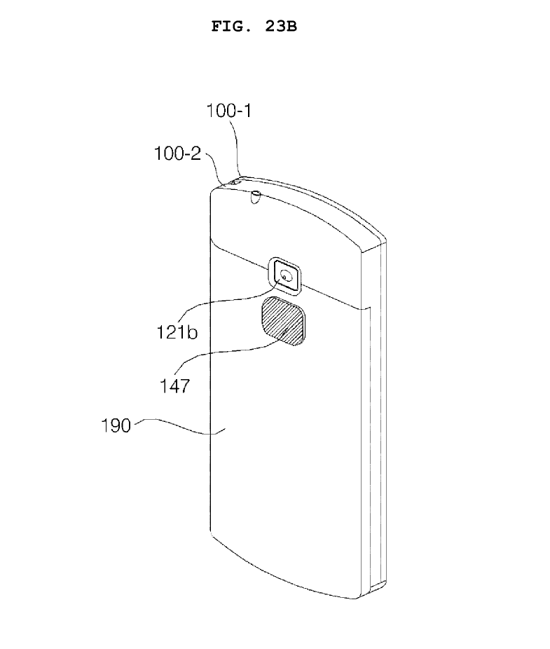

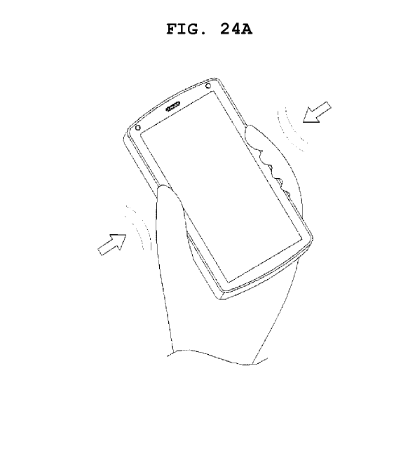

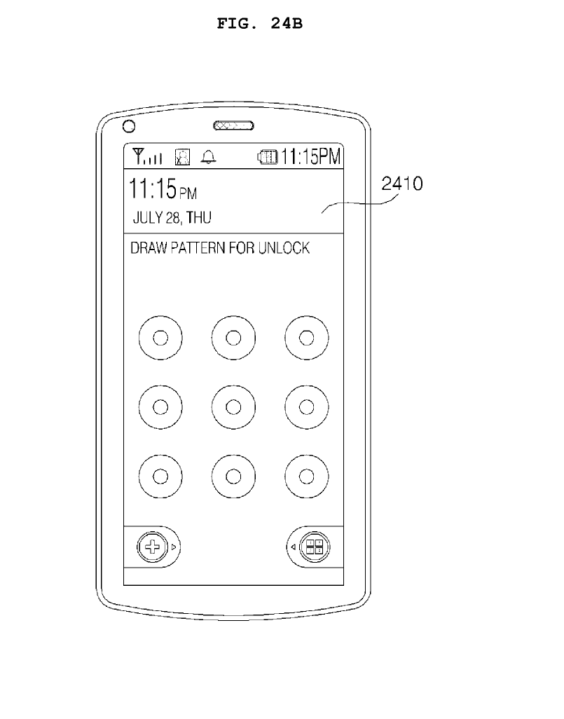

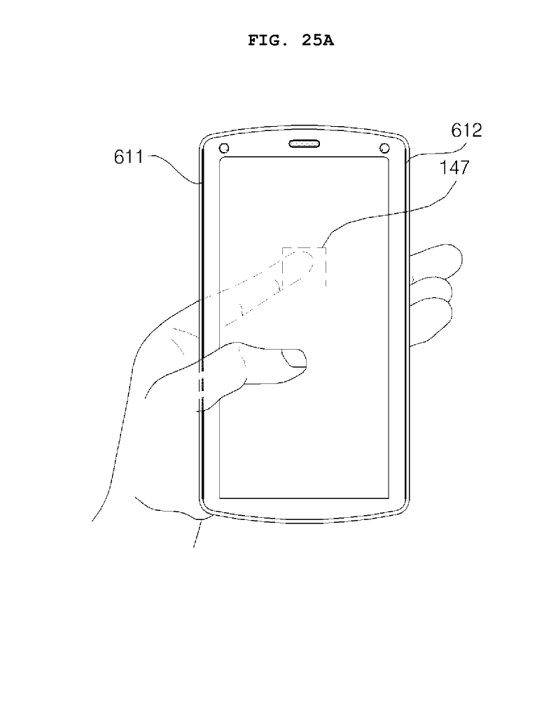

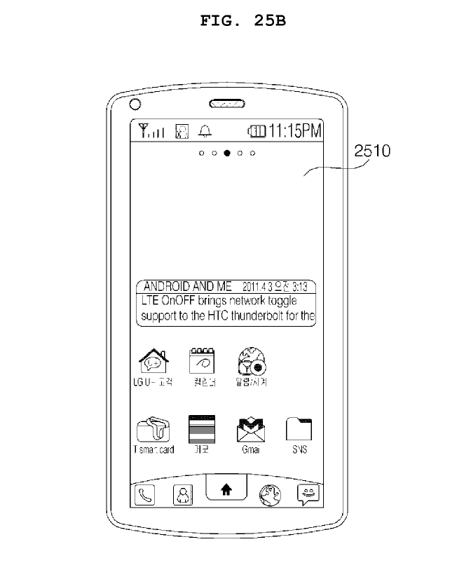

FIG. 23A is a perspective view of a mobile terminal according to an embodiment of the present invention when viewed from a front side thereof and FIG. 23B is a perspective view of the mobile terminal shown in FIG. 23A when viewed from a rear side thereof. Hereinafter, the components of the appearance of the mobile terminal according to the present invention will be described with reference to FIGS. 23A and 23B. Hereinafter, for convenience, among folder type, bar type, swing type and slider type mobile terminals, a bar type mobile terminal including a touchscreen at a front side thereof will be described. However, the present invention is not limited to the bar type mobile terminal and is applicable to all types of mobile terminals including the above-described types.

Referring to FIGS. 23A and 23B, a case forming the appearance of the mobile terminal 100 includes a front case 100-1 and a rear case 100-2. In a space formed by the front case 100-1 and the rear case 100-2, various electronic parts are mounted.

In a main body, that is, in the front case 100-1, a display 151, a first audio output module 153a and a first camera 121a are provided. A microphone 123 may be provided on the side surface of the rear case 100-2.

The mobile terminal is different from the mobile terminal shown in FIG. 2 in that the user input unit 130, that is, the first to third user input units 130a, 130b and 130c, are deleted and the fourth user input unit 130d and the fifth user input unit 130e are deleted.

The mobile terminal according to the present invention includes a pressure sensor for sensing pressure applied to a body. In the present embodiment, the pressure sensor may sense a grip gesture of a user to perform appropriate operation and may be a replacement for at least a hard key button.

As described with reference to FIG. 6, the pressure sensor may be placed at various positions in order to detect pressure. The pressure sensor may sense whether pressure is applied, a position at which pressure is applied and the level of the pressure and output the detected result to the controller 180.

The pressure sensor 143 may detect whether pressure is applied to the mobile terminal 100 and the level of the pressure. Accordingly, by performing predetermined operation only when the detected level of the pressure is equal to or greater than a predetermined value, it is possible to prevent malfunction while rapidly performing corresponding operation.

In another embodiment of the present invention, the mobile terminal shown in FIGS. 23A and 23B may further include at least some user input units of the user input unit 130.

Accordingly, a manufacturer may more freely design the appearance of the mobile terminal and simplify user input manipulation by deleting a plurality of key buttons.

If the touchpad and the display 151 have a layered structure, the display 151 may operate as a touchscreen capable of receiving information by a touch operation of the user.

A first audio output module 153a may be implemented in the form of a receiver or a speaker. A first camera 121a may be implemented in an appropriate form capable of photographing or filming an image or a moving image of a user. A microphone 123 may be implemented in an appropriate form such as user voice or other sounds.

Referring to FIG. 23B, a second camera 121b may be further mounted on the rear surface of the rear case 100-2. According to the embodiment, a fingerprint recognizer 147 may be further mounted. According to the embodiment, the fingerprint recognizer 147 may include a sensor for recognizing the fingerprint of the user and function as a touch pad.

The second camera 121b has a photographing direction substantially opposite to that of the first camera 121a and may have a different resolution than the first camera 121a.

A second audio output module (not shown) may be further mounted on the rear case 100-2. The second audio output module may implement a stereo function along with the first audio output module 153a and may be used to place a call in a speakerphone mode.

The interface 170 may be used as a passage through which data is exchanged with an external device. A broadcast signal reception antenna (not shown) may be provided in one of the front case 100-1 and the rear case 100-2 in addition to an antenna for telephone call. The antenna may be retractable from the rear case 100-2.

A power supply 190 for supplying power to the mobile terminal 100 may be mounted at the side of the rear case 100-2. The power supply 190 is, for example, a rechargeable battery and may be detachably coupled to the rear case 100-2, for charging.

Although the second camera 121b and the fingerprint recognizer 147 are mounted on the rear case 100-2 in the present embodiment, the present invention is not limited thereto. Alternatively, the second camera 121b may not be separately included, but the first camera 121a may be rotatably formed to photograph a subject located in the photographing direction of the second camera 121b.

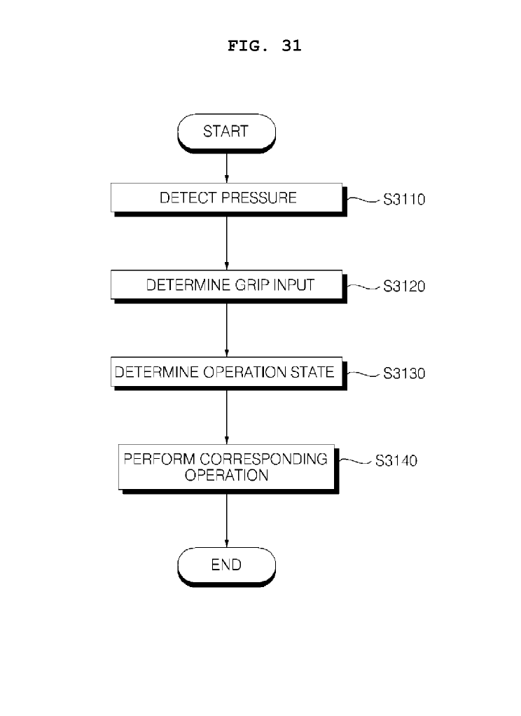

FIGS. 24A to 30D are views referred to for describing a method for operating a mobile terminal according to various embodiments of the present invention, and FIG. 31 is a flowchart illustrating a method for operating a mobile terminal according to an embodiment of the present invention.

Referring to the figures, the method for operating the mobile terminal according to the embodiment of the present invention may include a step S3110 of detecting pressure applied to the mobile terminal 100 via a plurality of sensors and a step S3120 of determining user grip input from the detected pressure.

If at least one of the detected level or position of the pressure or change in pressure satisfies a predetermined criterion, the controller 180 may determine that grip input for control of the mobile terminal 100 is received (S3120). For example, if the detected level of the pressure is greater than the predetermined reference value, the controller 180 may determine that appropriate grip input has been received.

The controller 180 determines an operation state of the mobile terminal 180 such as whether the mobile terminal 180 currently plays a moving image back, whether the telephone call is established or whether the mobile terminal 180 is turned off (S3130) and controls performance of operation corresponding to the operation state and the determined grip input (S3140). Accordingly, another operation may be performed with respect to the same grip input according to the operation state of the mobile terminal. Various commands may be input by several grip inputs set by a user or a manufacturer.

FIGS. 24A to 30D show various examples of various operation states and grip inputs of the mobile terminal. An embodiment of determining an operation state based on an image displayed on the display 151 and performing corresponding operation will be described with reference to FIG. 6.

First, FIGS. 24A and 24B show an example of turning a screen on by user grip input.

When the display 151 of the mobile terminal 100 is turned off, if the user grips the mobile terminal with pressure greater than a reference value so as to satisfy a predetermined criterion as shown in FIG. 24A, the display 151 may be turned on and a predetermined screen 2410 may be displayed as shown in FIG. 24B.

That is, predetermined user grip input in a state in which the display 151 is turned off may correspond to a command for turning the screen on and a separate screen on/off key button is not necessary.

The mobile terminal 100 may be maintained in a standby state for driving components for performing minimum functions such as signal reception, user command input, pressure sensing, etc. and then be switched to a wakeup state according to user grip input, such that a lock screen 2410 is displayed on the display 151.

FIGS. 25A and 25B shows another example of turning a screen on by user grip input. When the fingerprint recognizer 147 recognizes a pre-registered fingerprint of a user along with grip input as shown in FIG. 25A, a lock screen 2410 may not be displayed and but an unlock screen 2510 may be displayed on the display 151 as shown in FIG. 25B.

That is, the user applying pressure greater than the reference value along with fingerprint recognition may be set as unlock input. Thus, the controller 180 may perform unlock and mode switching without separate input.

Although the examples of turning the screen on using grip input are described with reference to FIGS. 24A to 25B, the screen may be turned off using grip input. For example, if pressure is not sensed or is remarkably decreased or if grip input predetermined by a user as an off command is detected, the controller 180 may turn the screen off.

If the operation state is different, user grip input may be regarded as another command.

For example, when the user establishes a telephone call with another person using the mobile terminal 100, the user increasing/decreasing the level of the pressure or changing the position of a predetermined finger may correspond to a volume increasing/decreasing command.

For example, the volume is increased if the user further increases pressure during the telephone call and is decreased if the user further decreases pressure during the telephone call. In contrast, the volume is decreased if the user further increases pressure during the telephone call.

Alternatively, the controller 180 may detect change in pressure and increase the volume if the user puts his/her index finger up during the telephone call and decrease the volume if the user puts his/her index finger down during the telephone call, and vice versa.

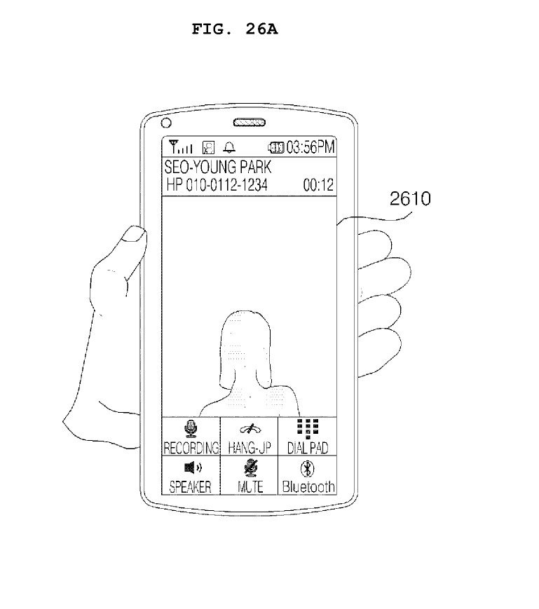

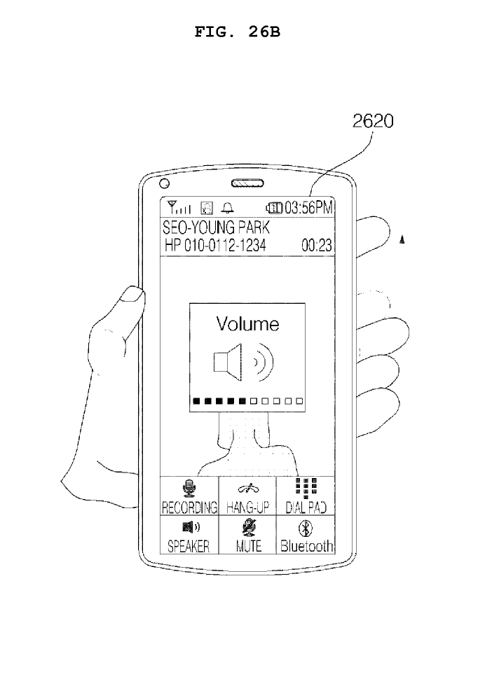

FIGS. 26A and 26B show an example of increasing the volume and displaying a volume control image 2620 on the display 151 as shown in FIG. 26B if the user puts his/her index finger up in a state in which a screen 2610 is displayed on the display 151 during a telephone call as shown in FIG. 26A and thus change in pressure level or position is detected.

If a camera operates, user grip input may be a capturing command.

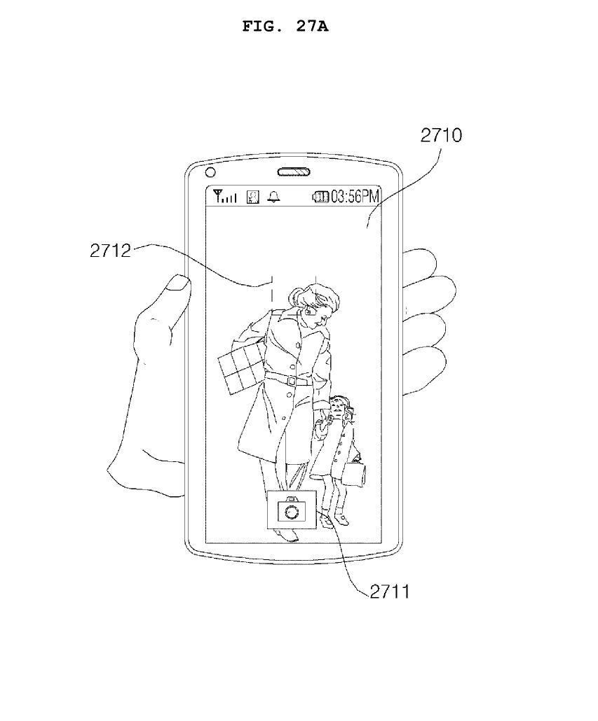

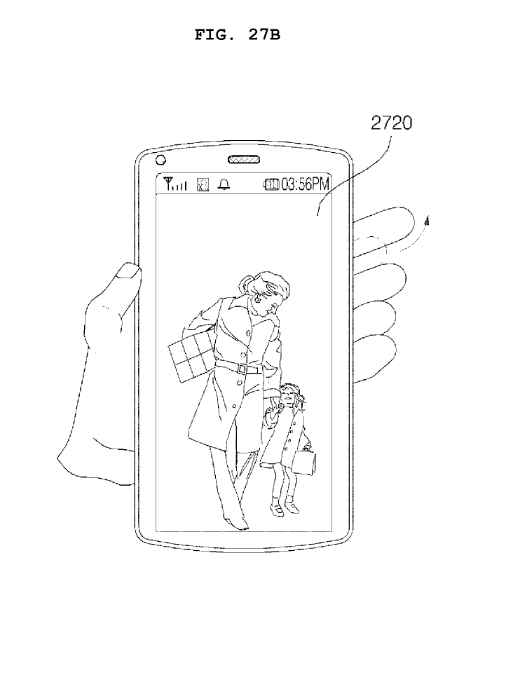

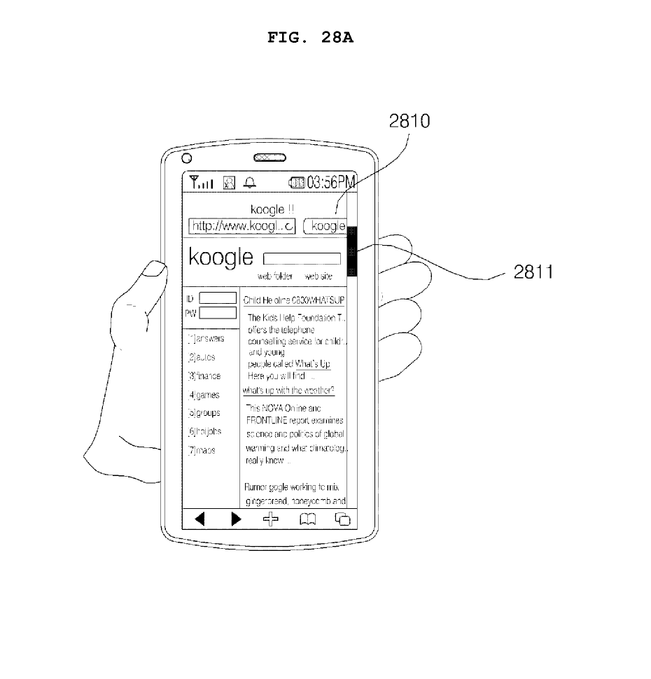

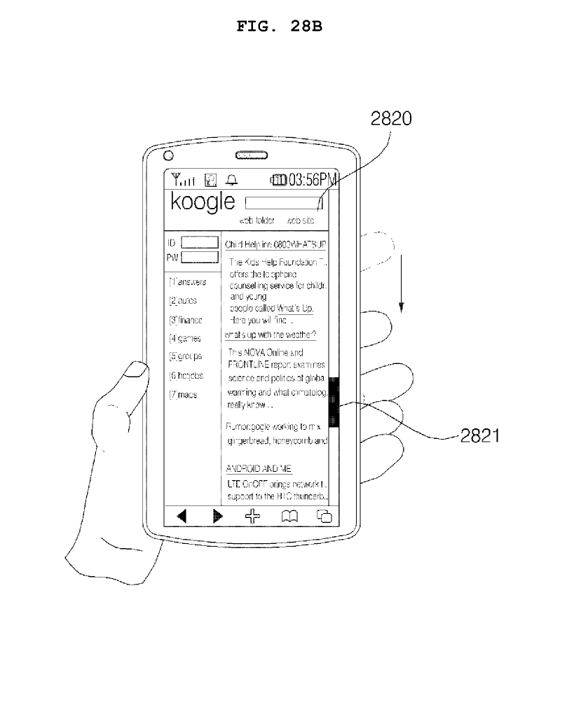

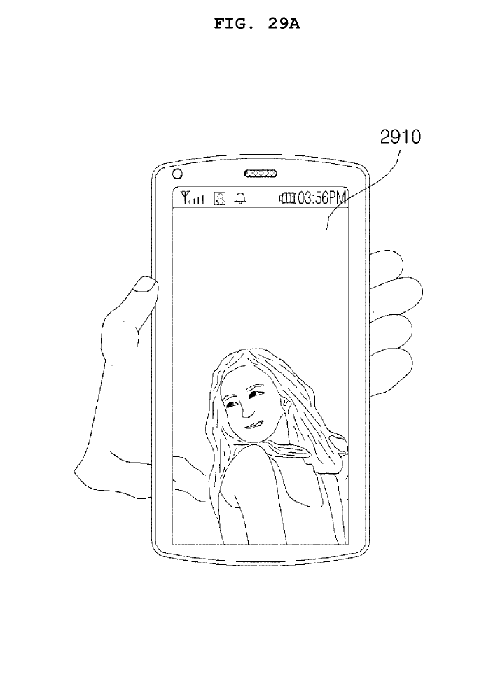

Referring to FIG. 27A, the user may touch a camera icon 2711 while viewing an image photographed by the camera to capture a predetermined image. In addition, a subject may be more accurately focused using a predetermined focus line 2712.

However, there is a difficulty in touching the camera icon 2711 in a state of carrying the mobile terminal 100 in hand, particularly, if the user uses the mobile terminal 100 single-handedly.

According to one embodiment of the present invention, user grip input and change thereof may be set as a photographing command. For example, as shown in FIG. 27B, detaching the index finger from the mobile terminal 100 or changing the position of the index finger may be set as a photographing command.

Accordingly, the controller 180 may photograph an image using the camera while detecting pressure level and position change, such that the user can more conveniently photograph a predetermined image 2720.

If the user searches for and utilizes a web page using a web browser, user grip input may be a page turning or scroll command. A user or a manufacturer may set or register grip input as a page turning or scroll command and the user may turn a page or scroll a screen without separate touch.

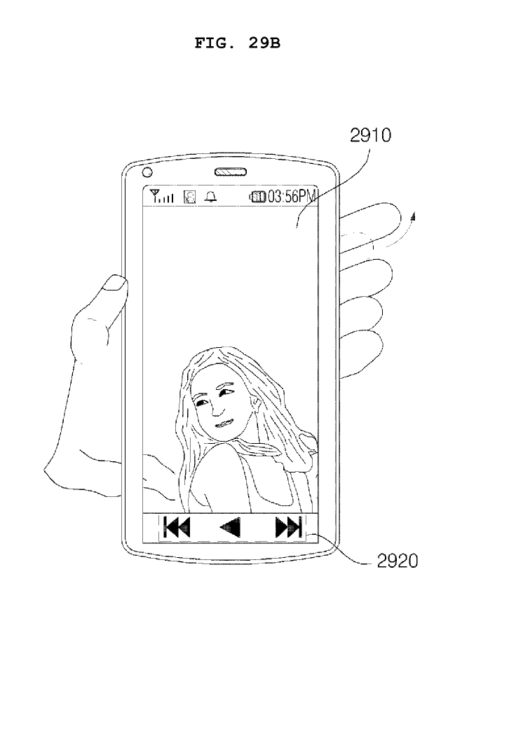

For example, referring to FIGS. 28A and 28B, the user may scroll the screen to view another screen 2820 as shown in FIG. 28B by moving his/her finger downward while viewing a predetermined Internet screen without touching a scroll bar 2811 or dragging as shown in FIG. 28A. Even in this case, a scroll bar 2821 moved according to the scroll result of the screen may be displayed.

As described with reference to FIGS. 27A to 28A, according to the present invention, predetermined hard key button may be replaced with user grip input to eliminate hard key button and to minimize or eliminate operation for touching a menu on a screen, such as a camera icon or a scroll bar.

If the user plays a moving image back, user grip input may be set as a command related to playback of the moving image.

For example, as shown in FIG. 29A, if the user detaches or move a predetermined finger from or on the screen while viewing a moving image 2910, the controller 180 may stop playback of the moving image 2910 and display, on the display 151, a moving image related control box 2920, such as rewind, play or fast forward, according to pressure level and position change, as shown in FIG. 29B.

Operations corresponding to grip inputs according to the operation states are exemplary and may be set or changed by a user or a manufacturer.

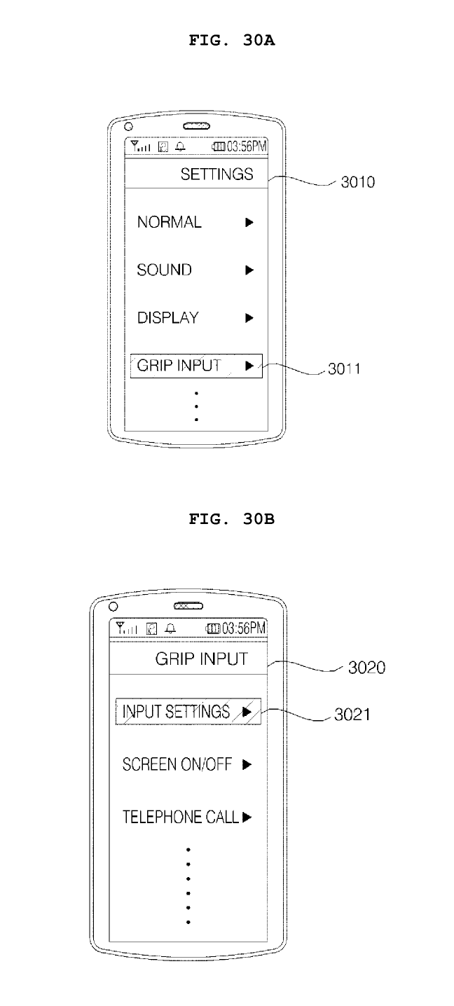

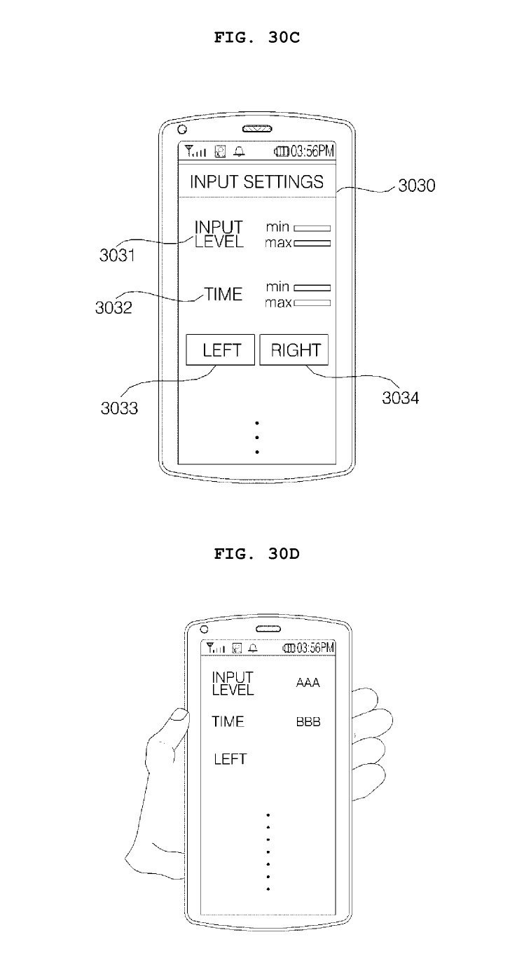

FIGS. 30A to 30D show examples in which a user sets grip input.

Referring to the figures, the user may select grip input 3011 on a settings screen 3010 as shown in FIG. 30A and set an input condition satisfying grip input according to various operation states 3020 and operation corresponding to grip input as shown in FIG. 30B.

The grip input function according to the present invention may be set to ON/OFF according to operation states.

The input condition satisfying grip input and operation corresponding to grip input may be manually input by the user, as shown in FIG. 30C. FIG. 30C shows an example of setting a normal input condition to be determined as grip input. For example, pressure level 3031, holding time 3032, whether a left hand 3033 or right hand 3034 is used, position (not shown) may be set.

The user may select any operation state from among a plurality of operation state items to set and register condition and operation according to states.

Unlike FIG. 30C, the user may not individually and manually input conditions but may directly perform grip operations to be used and automatically set the grip operations. As shown in FIG. 30D, if the user performs predetermined grip operation on a settings screen, the controller 180 may display an item related to the detected pressure on the display 151 and automatically set or register the predetermined grip operation.

According to the embodiment of the present invention, predetermined hard key button input and touch input are replaced with user grip input, such that a degree of freedom in design of the mobile terminal 100 may be increased and a user command input process may be simplified.

According to the embodiment of the present invention, a user can easily and conveniently utilize a function and rapidly perform a predetermined operation or function. Therefore, it is possible to increase user convenience.

The mobile terminal, the electronic apparatus and the method for operating the same according to the foregoing embodiments are not restricted to the embodiments set forth herein. Therefore, variations and combinations of the exemplary embodiments set forth herein may fall within the scope of the present invention.

The method for operating an image display apparatus according to the foregoing embodiments may be implemented as code that can be written to a computer-readable recording medium and can thus be read by a processor. The computer-readable recording medium may be any type of recording device in which data can be stored in a computer-readable manner. Examples of the computer-readable recording medium include a ROM, a RAM, a CD-ROM, a magnetic tape, a floppy disc, an optical data storage, and a carrier wave (e.g., data transmission over the Internet). The computer-readable recording medium can be distributed over a plurality of computer systems connected to a network so that computer-readable code is written thereto and executed therefrom in a decentralized manner. Functional programs, code, and code segments needed for realizing the embodiments herein can be construed by one of ordinary skill in the art.

As described above, according to the present invention, in a state in which an AR screen is displayed through a head mounted display communicatively connected to a mobile terminal, various operations related to the mobile terminal may be controlled using a gesture input such as predetermined hand motion. Eye tracking is performed on the AR screen displayed through the head mounted display and a virtual image related to the gesture input is displayed at an eye position of a user. Thus, the user can conveniently control an operation related to the mobile terminal.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for operating a mobile terminal, the method comprising:
detecting whether pressure is applied via a plurality of sensors;
detecting the level of the pressure;
entering a call recording mode for recording content of a telephone call if the detected level of the pressure is greater than a reference value and the telephone call is established; and
entering a memo mode if the detected level of the pressure is greater than the reference value and the telephone call is not established.

2. The method according to claim 1, wherein the entering the memo mode includes entering a first memo mode for recording voice if a user's face approaches the mobile terminal and, otherwise, entering a second memo mode for capturing a screen and writing a memo on a captured image.

3. The method according to claim 2, further comprising activating a camera or a detector if the detected level of the pressure is greater than the reference value and the telephone call is not established.

4. The method according to claim 1, further comprising:
displaying, on a display, a menu for selecting one of a first memo mode for recording voice and a second memo mode for capturing a screen and writing a memo on a captured image; and
receiving input for selecting one of the first memo mode and the second memo mode,
wherein the entering the memo mode includes entering the selected memo mode.

5. The method according to claim 1, further comprising detecting a position at which pressure is applied.

6. The method according to claim 5, wherein, in the entrance to the call recording mode or the memo mode, the mobile terminal enters a corresponding mode depending on whether a telephone call is established, if pressure greater than the reference value is applied to both opposite side surfaces of the mobile terminal.

7. The method according to claim 1, further comprising outputting at least one of an audio effect and a vibration effect if the detected pressure reaches the reference value.

8. A method for operating a mobile terminal, the method comprising:
displaying a predetermined image on a display;
detecting whether pressure is applied via a plurality of sensors;
detecting the level of the pressure; and
performing corresponding operation based on attributes of the image if the detected level of the pressure is greater than a reference value.

9. The method according to claim 8, wherein, if the predetermined image is a lock screen, the performing the corresponding operation includes entering a voice recording mode for recording user voice.

10. The method according to claim 8, wherein, if the predetermined image is using screen, the performing the corresponding operation includes capturing the predetermined image and displaying a menu item for memo input in some regions of the display.

11. The method according to claim 10, further comprising:
receiving user memo input on the captured image; and
storing content of the input memo along with the captured image.

12. The method according to claim 8, wherein, if the predetermined image is a call related screen, the performing the corresponding operation includes entering a call recording mode for recording content of a telephone call.

13. The method according to claim 12, wherein the call recording mode is terminated when the telephone call is terminated or a user termination command is input.

14. The method according to claim 12, further comprising:
storing content of the telephone call when the telephone call begins; and
merging and storing content recorded during the call recording mode and content stored during a predetermined time before entering the call recording mode, if the call recording mode is terminated.

15. The method according to claim 8, further comprising detecting a position at which pressure is applied.

16. The method according to claim 15, wherein the performing the corresponding operation includes performing the corresponding operation if pressure is applied to both opposite side surfaces of the mobile terminal.

17. The method according to claim 8, further comprising outputting at least one of an audio effect and a vibration effect if the detected pressure reaches the reference value.

18. A mobile terminal comprising:
a plurality of pressure sensors for detecting whether pressure is applied and detecting the level of the pressure; and
a controller for controlling entrance to a call recording mode for recording content of a telephone call if the detected level of the pressure is greater than a reference value and the telephone call is established and entrance to a memo mode if the detected level of the pressure is greater than the reference value and the telephone call is not established.

19. The mobile terminal according to claim 18, further comprising a detector for detecting whether a user's face approaches the mobile terminal,
wherein the controller controls activation of the detector if the detected level of the pressure is greater than the reference value and the telephone call is not established.

20. A mobile terminal comprising:
a display for displaying a predetermined image;
a plurality of pressure sensors for detecting whether pressure is applied and detecting the level of the pressure; and
a controller for controlling performance of corresponding operation based on attributes of the image if the detected level of the pressure is greater than a reference value.
